(19) United States
(12) Patent Application Publication
(10) Pub. No.: US 2021/0334611 A1
(43) Pub. Date: Oct. 28, 2021

(54) PRINT CONTROL APPARATUS AND PRINT CONTROL METHOD CAPABLE OF EXECUTING PRINTING WITH PAPER INSERTION FUNCTION

(71) Applicant: SHARP KABUSHIKI KAISHA, Osaka (JP)

(72) Inventor: NAOKI KODAMA, Osaka (JP)

(21) Appl. No.: 17/235,941

(22) Filed: Apr. 21, 2021

(30) Foreign Application Priority Data
Apr. 27, 2020 (JP) 2020-078352

(51) Int. Cl. G06K 15/02; G06K 15/16; G06K 15/00

(52) U.S. Cl. CPC G06K 15/1809; G06K 15/16; G06K 15/1805; G06K 15/4065; G06K 15/002

(57) ABSTRACT

According to an embodiment, provided is a print control apparatus including: a processor; and a memory, where the memory stores instructions that cause the processor to: accept, when printing with paper insertion function is to be performed, a setting by a user related to the paper insertion function; acquire information related to a paper setting of at least one of at a point of time of setting the paper insertion function, before the point of time, and after the point of time, as paper information; and determine a default setting of a menu which accepts the setting of the paper insertion function based on the acquired paper information.

### BACKGROUND OF THE INVENTION

### Field of the Invention

The present invention relates to a print control apparatus and a print control method capable of executing printing with paper insertion function.

### Description of the Background Art

Some of devices which perform printing, such as copiers and printers, include ones that are capable of handling printing with paper insertion function. Printing with paper insertion function corresponds to the function of inserting paper such as a cover sheet, interleaving paper, and partition paper onto paper of a text body of the printing.

For insertion paper for printing with paper insertion function, paper settings different from those of the text body are often used. Thus, the printing with paper insertion function is configured to accept the paper settings that are independent of the text body.

However, since the setting screen of the paper insertion function provides a variety of setting items such as a paper insertion method, an insertion position, and a tray for the insertion paper, the specifications of the setting screen tend to be complicated and difficult to understand. Further, if there are many settings, the setting intended by the user cannot be made unless he/she accesses a deep hierarchy of a menu, and thus the operational procedure tends to be complicated.

As the printing devices are made multifunctional, the operation is complicated. Correspondingly to the above, the function as described below, which is to store the setting made by the user as an operation history, and allow the user to call and reuse that setting, is known.

If the setting is made to store the operation history of each user in a state where the user is logged in, the operation history of each user is registered in a first storage means. Meanwhile, if the setting is made not to store the operation history of each user, the operation history is registered in a second storage means in a log-in state, and the operation history is deleted from the second storage means at the time of logout. The above function satisfies both of effective use of the operation history and protection of privacy in this way (see, for example, Japanese Unexamined Patent Application Publication No. 2016-019051).

Also, storing a series of user inputs as an input history, and displaying an interface for operating an electronic device on the basis of the input history is known. Calculation is performed to specify which operation state, from among a plurality of operation states determined in advance on the basis of the input histories, the user belongs to. The operational purpose of the user and the availability thereof are calculated on the basis of the user's operation state calculated and a user model. On the basis of the calculation result, a button which can be selected by the user is displayed (see, for example, Japanese Unexamined Patent Application Publication No. H8-153004).

The technologies related to Japanese Unexamined Patent Application Publication No. 2016-019051 and Japanese Unexamined Patent Application Publication No. H8-153004 place importance on versatility. However, as regards printing with paper insertion function, options for the setting related to insertion paper, which conform to the user's intention, can be provided with relatively simple processing accurately on the basis of an operation performed before or after the setting and relevance to the type of the function, etc.

The present invention has been conceived in consideration of the above conditions, and provides a method for assisting a user by providing, when printing with paper insertion function is set, a default setting according to a situation.

### SUMMARY OF THE INVENTION

The present invention provides a print control apparatus including: a processor; and a memory, where the memory stores instructions that cause the processor to: accept, when printing with paper insertion function is to be performed, a setting by a user related to the paper insertion function; acquire information related to a paper setting of at least one of at a point of time of setting the paper insertion function, before the point of time, and after the point of time, as paper information; and determine a default setting of a menu which accepts the setting of the paper insertion function based on the acquired paper information

Also, from another perspective, the present invention provides a print control method including: accepting, when printing with paper insertion function is to be performed, a setting by a user related to the paper insertion function; acquiring information related to a paper setting of at least one of at a point of time of setting the paper insertion function, before the point of time, and after the point of time, as paper information; and determining a default setting of a menu which accepts the setting of the paper insertion function on the basis of the acquired paper information.

The print control apparatus according to the present invention includes: the paper information acquirer which acquires information related to a paper setting of at least one of at a point of time of setting the paper insertion function, before the point of time, and after the point of time, as paper information; and the menu controller which determines a default setting of a menu which accepts the setting of the paper insertion function on the basis of the acquired paper information. Therefore, it is possible to provide a default setting according to a situation when printing with paper insertion function is set.

The print control method according to the present invention also brings about similar effects and advantages.

### BRIEF DESCRIPTION OF THE DRAWINGS

FIG. 1 is a block diagram illustrating a configuration of a digital multifunction peripheral, which is one aspect of a printing apparatus according to the present embodiment;

FIG. 2 is a perspective view showing the outer appearance of the digital multifunction peripheral illustrated in FIG. 1;

FIG. 3A is an explanatory diagram illustrating the function of cover sheet insertion of the present embodiment;

FIG. 3B is an explanatory diagram illustrating the function of interleaving paper insertion of the present embodiment;

FIG. 3C is an explanatory diagram illustrating the function of partition paper insertion of the present embodiment;

FIG. 3D is an explanatory diagram illustrating the function of OHP film interleaving paper insertion of the present embodiment;

FIG. 4A is an explanatory diagram illustrating a copy operation basic screen of the present embodiment;

FIG. 4B is an explanatory diagram illustrating a paper setting screen of the present embodiment;

FIG. 4C is an explanatory diagram illustrating a manual feed tray screen of the present embodiment;

FIG. 4D is an explanatory diagram illustrating a paper type setting screen of the present embodiment;

FIG. 5A is an explanatory diagram illustrating a function setting screen of the present embodiment;

FIG. 5B is an explanatory diagram illustrating a paper insertion setting screen of the present embodiment;

FIG. 5C is an explanatory diagram illustrating a cover sheet insertion setting screen of the present embodiment;

FIG. 6A is a first flowchart of processing related to paper insertion function in Embodiment 1;

FIG. 6B is a second flowchart of processing related to paper insertion function in Embodiment 1;

FIG. 7 is a flowchart of processing related to paper insertion function in Embodiment 2;

FIG. 8 is a flowchart of processing related to paper insertion function in Embodiment 3; and

FIG. 9 is a flowchart of processing related to paper insertion function in Embodiment 4.

### DESCRIPTION OF THE PREFERRED EMBODIMENTS

The present invention will now be described in detail with reference to the accompanying drawings. Note that the following explanations are given merely for describing examples in all respects, and should not be construed as limiting the present invention.

### Embodiment 1

### Configuration of Print Control Apparatus

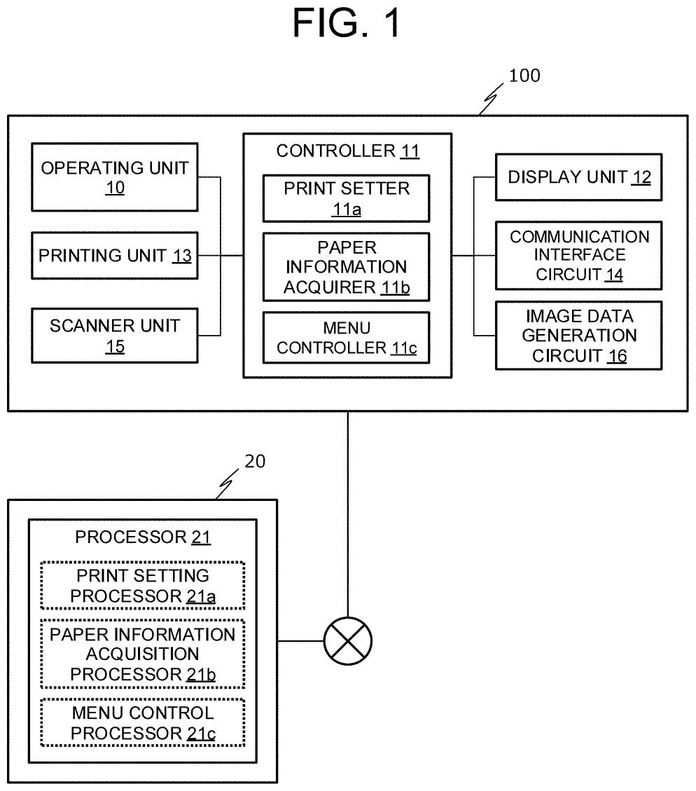

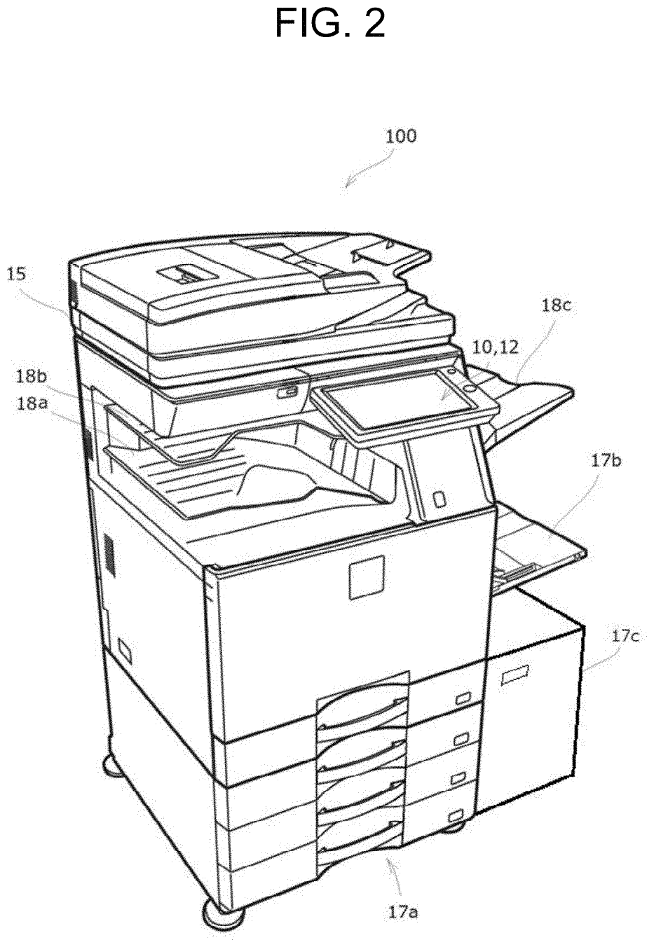

FIG. 1 is a block diagram illustrating a configuration of a digital multifunction peripheral, which is one aspect of a printing apparatus according to the present embodiment. FIG. 2 is a perspective view showing the outer appearance of the digital multifunction peripheral illustrated in FIG. 1.

In the present embodiment, a digital multifunction peripheral is given as an example of an apparatus which performs printing with paper insertion function. However, the apparatus is not limited to the above. For example, a copy device, a facsimile machine, a printer device, or the like, may be applied, and the apparatus is not limited to the aforementioned devices as long as it is related to printing.

As illustrated in FIG. 1, the digital multifunction peripheral 100 is provided with an operating unit 10, a controller 11, a display unit 12, a printing unit 13, a communication interface circuit 14, a scanner unit 15, and an image data generation circuit 16.

Further, the digital multifunction peripheral 100 can be connected to an external information processing device 20 via the communication interface circuit 14. An example of the information processing device 20 is a personal computer which performs communication related to a print job with the digital multifunction peripheral 100. However, the information processing device 20 is not limited to a personal computer, and may be, for example, a smartphone, a tablet terminal, a print server, or the like.

Further, as illustrated in FIG. 2, the digital multifunction peripheral 100 is provided with a multistage tray 17a (i.e., four paper feed trays, which are tray 1 to tray 4 named from the upper side), a manual feed tray 17b, a large-capacity tray 17c, and paper discharge trays 18a, 18b and 18c. In the present specification, the multistage tray 17a, the manual feed tray 17b, and the large-capacity tray 17c are collectively referred to as paper feed trays.

The controller 11 and the printing unit 13, and the controller 11 and the scanner unit 15 are connected to each other by a bus, and are mutually communicable.

The controller 11 is provided with a print setter 11a which receives settings related to a print job that the digital multifunction peripheral 100 is to execute. Further, the controller 11 is provided with a paper information acquirer 11b which acquires information related to paper set in respective paper feed trays or settings made for those paper feed trays with respect to paper. Furthermore, the controller 11 is provided with a menu controller 11c which receives settings related to the print job.

Here, the controller 11, or more specifically, each of the print setter 11a, the paper information acquirer 11b, and the menu controller 11c, corresponds to a print control apparatus.

Also, the controller 11 controls the operation of each element of the digital multifunction peripheral 100 indicated in FIG. 1. Specifically, the controller 11 is composed of hardware resources such as a CPU or an MPU (where the aforementioned two are collectively referred to as a CPU) as the main hardware resource, and a memory, an input-output interface circuit, and a timer circuit.

At least a part of the memory provided in the controller 11 may be a rewritable non-volatile memory. The CPU provided in the controller 11 reads a control program stored in the memory to execute processing according to the control program.

The CPU causes the display unit 12 to display a display related to a user interface in accordance with the contents of the control program stored in the memory. Then, an operation that the user performs on the operating unit 10 is received. The CPU performs processing related to the received operation as the print setter 11a, the paper information acquirer 11b, and the menu controller 11c. Further, the CPU controls the hardware of the digital multifunction peripheral 100 in accordance with the control program, and realizes the function such as printing.

In the controller 11, as the CPU executes the control program stored in the memory, the processing of receiving the user operation, or more specifically, the function performed as the print setter 11a, the paper information acquirer 11b, and the menu controller 11c, is realized. Also, the controller 11 realizes processing of the display and control of the hardware.

The operating unit 10 is provided on a housing of the digital multifunction peripheral 100, and is composed of, for example, a plurality of operation buttons for receiving an operation of the user, and a touch panel disposed on a display surface of the display unit 12. The controller 11 recognizes a signal indicating an input operation on the operating unit 10.

The display unit 12 is composed of, for example, a liquid crystal display device, and can display various kinds of information and images, etc., on the basis of an input or the like received by the operating unit 10. The controller 11 generates the contents to be displayed on the display unit 12, and updates the display. In accordance with the above, the display unit 12 displays various kinds of information and images.

The scanner unit 15 which reads an image of a document is connected to the controller 11.

The scanner unit 15 executes image reading processing in copy, fax, and scanner jobs under the control of the controller 11. That is, a document image is read, and is converted into an image signal.

The image data generation circuit 16 generates image data on the basis of the image signal that the scanner unit 15 outputs.

The multistage tray 17a is composed of a plurality of paper feed trays, which store paper of various sizes individually. The manual feed tray 17b can feed paper of various sizes and of various types. The large-capacity tray 17c stores paper of a size that is most commonly used (for example, paper of A4 size).

Under the control of the controller 11, a paper feed mechanism, which is not illustrated in FIG. 1 or FIG. 2, feeds the paper in a designated paper feed tray into the printing apparatus and conveys the fed paper to the printing unit 13.

Under the control of the controller 11, the printing unit 13 performs printing of the specified image data on the paper which has been fed from one of the paper feed trays.

A paper ejection mechanism, which is not illustrated in FIG. 1 or 2, ejects the paper printed by the printing unit 13 to one of the paper discharge trays 18a, 18b, and 18c.

The communication interface circuit 14 is an interface for performing data communication with an external device via a network. In the present embodiment, the digital multifunction peripheral 100 communicates with the information processing device 20 connected via the network. In the present example, the information processing device 20 receives the user operation related to the setting of a print job which should be executed by the digital multifunction peripheral 100. Also, the digital multifunction peripheral 100 generates and provides print data for printing. The printing unit 13 performs printing of the provided print data.

The information processing device 20 is provided with a processor 21. The processor 21 may be provided with a print setting processor 21a, a paper information acquisition processor 21b, and a menu control processor 21c.

The following two modes are assumed as the mode in which the information processing device 20 receives the user operation related to the setting of a print job.

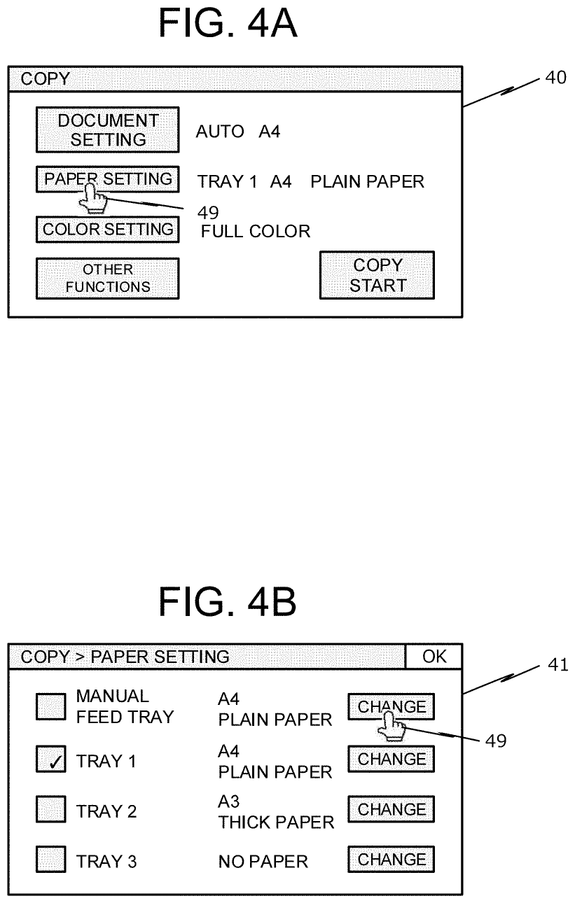

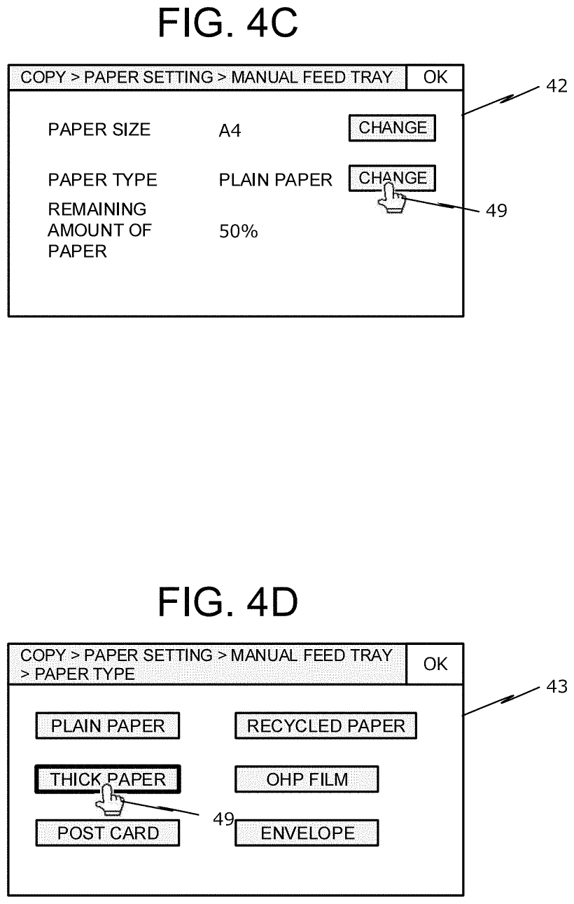

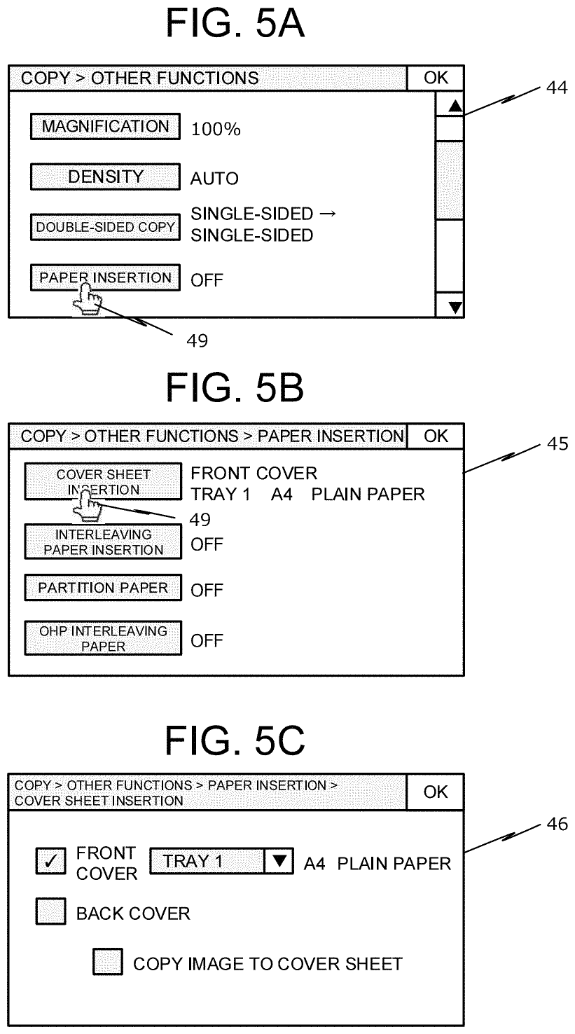

The first mode is that in which the information processing device 20 sends information related to the operation received by the information processing device 20 to the digital multifunction peripheral 100, and the controller 11 of the digital multifunction peripheral 100 proactively performs the processing for the operation. More specifically, for example, a menu screen (for example, FIGS. 4A to 4D and 5A to 5C) related to a print setting that is displayed by the information processing device 20 is a web screen provided by the controller 11 of the digital multifunction peripheral 100, and the user performs the operation related to printing by using the web screen. According to the above mode, the print setter 11a, the paper information acquirer 11b, and the menu controller 11c of the controller 11 process the user operation on the information processing device 20. The above processing of the first mode is the same as the processing in which the controller 11 processes the user operation on the operating unit 10.

The second mode is that in which the information processing device 20 proactively performs the processing for the operation. More specifically, for example, a printer driver installed on the information processing device 20 provides a menu screen related to the print setting, and the user performs the operation by using the menu screen. According to the above mode, the processor 21 of the information processing device 20 processes the user operation on the information processing device 20, which has been performed with respect to the setting of a print job. That is, the print setting processor 21a, the paper information acquisition processor 21b, and the menu control processor 21c process the operation related to the setting of the print job that has been received by the information processing device 20.

In other words, the above-described operation on the information processing device 20 is processed by the print setting processor 21a, the paper information acquisition processor 21b, and the menu control processor 21c. The above elements take on the same functions as those of the print setter 11a, the paper information acquirer 11b, and the menu controller 11c which process the operation performed on the operating unit 10. According to the second mode, the print setting processor 21a, the paper information acquisition processor 21b, and the menu control processor 21c correspond to the print control apparatus.

Although specific operations and processing will be described by taking the first mode as an example, the same applies to the operations and processing of the second mode.

### Paper Insertion Function and Operation of Settings

A paper insertion function is a general term for the function of inserting a sheet of paper into a printing of a body text. In the present embodiment, the paper insertion function is a general term for the function of cover sheet insertion, interleaving paper insertion, partition paper insertion, and overhead projector (OHP) film interleaving paper insertion.

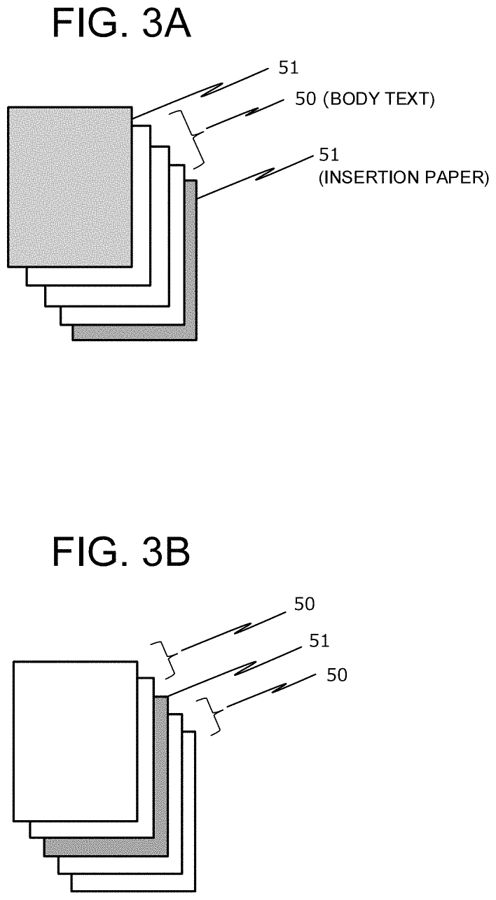

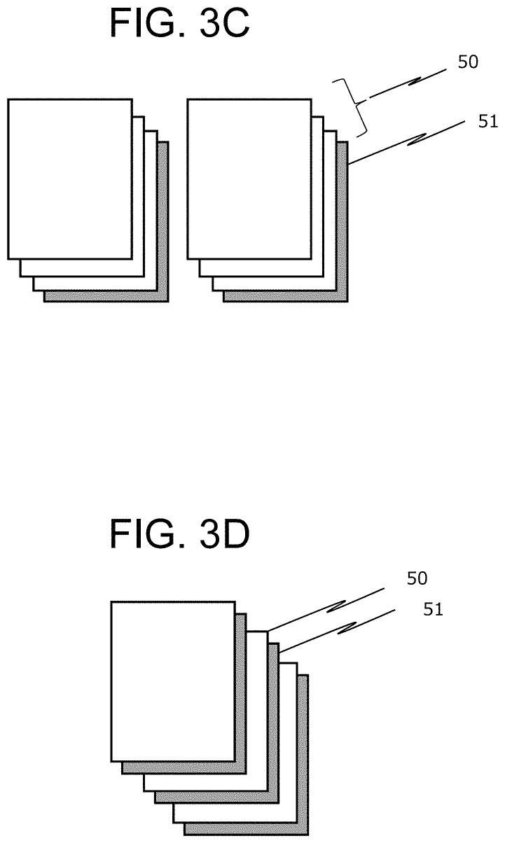

The function of the cover sheet insertion corresponds to the function of inserting insertion paper 51 serving as a cover sheet on at least either the front side or the back side of a body text 50 printed in units of copies (see FIG. 3A). As the cover sheet, paper of a type different from that of the body text 50 (for example, thick paper) is usually used. On the cover sheet, printing may or may not be performed.

The function of the interleaving paper insertion corresponds to the function of inserting the insertion paper 51, as the interleaving paper, on a specific page in the middle of the body text 50 printed in units of copies (see FIG. 3B). As the interleaving paper, paper of a type different from that of the body text 50 (for example, colored paper) is usually used. On the interleaving paper, printing may or may not be performed. The setting of combining the cover sheet insertion and the interleaving paper insertion is also possible.

The partition paper insertion refers to the function of inserting the insertion paper 51 which serves as a partition between copies of the body text 50, which is printed in units of copies, or between print jobs (see FIG. 3C). Partition paper may be a sheet of paper of a type different from that of the body text 50, or may be of the same type of paper as that of the body text 50. Since the partition paper is merely a mark for separation, printing is usually not performed on the partition paper.

The OHP film interleaving paper insertion refers to the function applied when the body text 50 is printed on an OHP film (a transparent sheet made of resin) which is easily charged with static electricity, and this function inserts the insertion paper 51 serving as the interleaving paper for each sheet of OHP film printed as the body text 50 (see FIG. 3D). As the interleaving paper, paper of a type different from that of the body text 50 (for example, white paper) is usually used. On the interleaving paper, printing may or may not be performed.

FIGS. 4A to 4D and FIGS. 5A to 5C are explanatory diagrams illustrating an example of a copy operation screen to be displayed on the display unit 12 by the menu controller 11c in the present embodiment.

FIG. 4A shows a copy basic operation screen 40 displayed on the display unit 12. The copy basic operation screen 40 is a screen that the menu controller 11c causes the display unit 12 to display in response to an operation of selecting a copy function on a home screen (not shown) displayed on the display unit 12.

As shown in FIG. 4A, the menu controller 11c causes various operation buttons to be displayed on the copy basic operation screen 40. In addition, paper information related to the selected paper feed tray, information on a document, the state of the color setting, etc., are displayed. When the user touches “Paper Setting” button from among the operation buttons displayed on the copy basic operation screen 40 with a finger 49, the print setter 11a recognizes that operation. In response to the recognized operation, the menu controller 11c switches the display of the display unit 12 to a paper setting screen 41.

As shown in FIG. 4B, the menu controller 11c causes the state of the currently selected paper feed tray to be displayed on the paper setting screen 41. Further, pieces of paper information with respect to the paper feed trays are displayed, respectively. Together with the above information, “Change” buttons for accepting the setting change of the respective paper feed trays are displayed. Also, in the upper right corner, “OK” button for accepting confirmation of the setting is displayed.

When the user touches the “Change” button for the manual feed tray with the finger 49 on the paper setting screen 41, the print setter 11a recognizes that operation. In response to the recognized operation, the menu controller 11c switches the display of the display unit 12 to a manual feed tray screen 42.

As shown in FIG. 4C, the menu controller 11c causes the manual feed tray screen 42 to display the paper size, the paper type, and the remaining amount of paper, which are the paper information of the manual feed tray. Further, “Change” buttons for accepting the setting change for the paper size and the paper type are displayed. Also, in the upper right corner, “OK” button for accepting confirmation of the setting is displayed. Note that the manual feed tray 17b of the present embodiment lacks the function of detecting the paper size, and thus the user sets the size of the paper having been set on the manual feed tray screen 42. The same applies to the paper type.

When the user touches the “Change” button for the paper type with the finger 49 on the manual feed tray screen 42, the print setter 11a recognizes that operation. In response to the recognized operation, the menu controller 11e switches the display of the display unit 12 to a paper type setting screen 43.

As shown in FIG. 4D, the menu controller 11c causes the paper type setting screen 43 to display setting buttons related to a plurality of paper types that can be set for the manual feed tray 17b. Also, in the upper right corner, “OK” button for accepting confirmation of the setting is displayed.

When the user touches “Thick Paper” button with the finger 49 on the paper type setting screen 43, the print setter 11a recognizes that operation. In response to the recognized operation, the menu controller 11c changes the setting of the paper type of the manual feed tray 17b from “Plain Paper”, which is currently set, to “Thick Paper”. Further, when the user touches the “OK” button, in response to that operation, the menu controller 11c returns the paper type setting screen 43 being displayed to the manual feed tray screen 42 shown in FIG. 4C, and updates the display of the paper type of the manual feed tray on the manual feed tray screen 42 so that “Thick Paper”, which is the paper type after the change, is displayed.

In the above, the operational procedure for changing the setting of the paper type of the manual feed tray 17b has been described.

Meanwhile, when the user touches “Other Functions” button on the copy basic operation screen 40 shown in FIG. 4A, the print setter 11a recognizes that operation. In response to the recognized operation, the menu controller 11c switches the display of the display unit 12 to a function setting screen 44.

As shown in FIG. 5A, the menu controller 11c causes the function setting screen 44 to display setting operation buttons for various functions such as “Magnification”, “Density”, and “Double-sided Copy”. Also, the current settings regarding the aforementioned functions are displayed. Further, in the upper right corner, “OK” button for accepting confirmation of the setting is displayed.

When the user touches “Paper Insertion” button on the function setting screen 44, the print setter 11a recognizes that operation. In response to the recognized operation, the menu controller 11c switches the display of the display unit 12 to a paper insertion setting screen 45.

As shown in FIG. 5B, the menu controller 11c causes the paper insertion setting screen 45 to display setting buttons for various functions included in the paper insertion function. Also, the current settings regarding the aforementioned functions are displayed. Further, in the upper right corner, “OK” button for accepting confirmation of the setting is displayed.

The operation buttons of “Cover Sheet Insertion”, “Interleaving Paper Insertion”, “Partition Paper” and “OHP Interleaving Paper”, which are displayed on the paper insertion setting screen 45, correspond to the functions of the cover sheet insertion, the interleaving paper insertion, the partition paper insertion, and the OHP film interleaving paper insertion described above, respectively.

When the user touches the “Cover Sheet Insertion” button, the print setter 11a recognizes that operation. In response to the recognized operation, the menu controller 11c switches the display of the display unit 12 to a cover sheet insertion setting screen 46.

As shown in FIG. 5C, the menu controller 11c causes the cover sheet insertion setting screen 46 to display a setting menu related to the function of the cover sheet insertion and the current settings. Also, in the upper right corner, “OK” button for accepting confirmation of the setting is displayed. Currently, the setting is made to apply a front cover, and tray 1 corresponding to the topmost tray of the multistage tray 17a is selected as the paper feed tray for the insertion paper, which serves as the front cover. The paper size of the paper in tray 1 is A4, and the paper type of the same is plain paper.

Here, when the user operates, for example, a drop-down menu related to the setting of the paper feed tray for the front cover to change the paper feed tray to another paper feed tray, the print setter 11a recognizes that operation. In response to the recognized operation, the menu controller 11c changes the setting of the paper feed tray for the insertion paper as the front cover from the currently set tray 1 to a newly set paper feed tray. When the user touches the “OK” button, in response to this operation, the menu controller 11c returns the cover sheet insertion setting screen 46 to the paper insertion setting screen 45 shown in FIG. 5B, and updates the display of the paper feed tray for the front cover of the cover sheet insertion so that a paper feed tray after the change is displayed.

### Processing of Print Setting Related to Paper Insertion Function

In the following, a specific example of the print setting related to the paper insertion function will be described with reference to flowcharts. In the flowcharts mentioned below, when the paper insertion function is set, a paper feed tray in which paper has been set or for which a paper setting change has been made within a predetermined period of before or after the time of the paper insertion function setting is set to a default setting paper feed tray for the insertion paper.

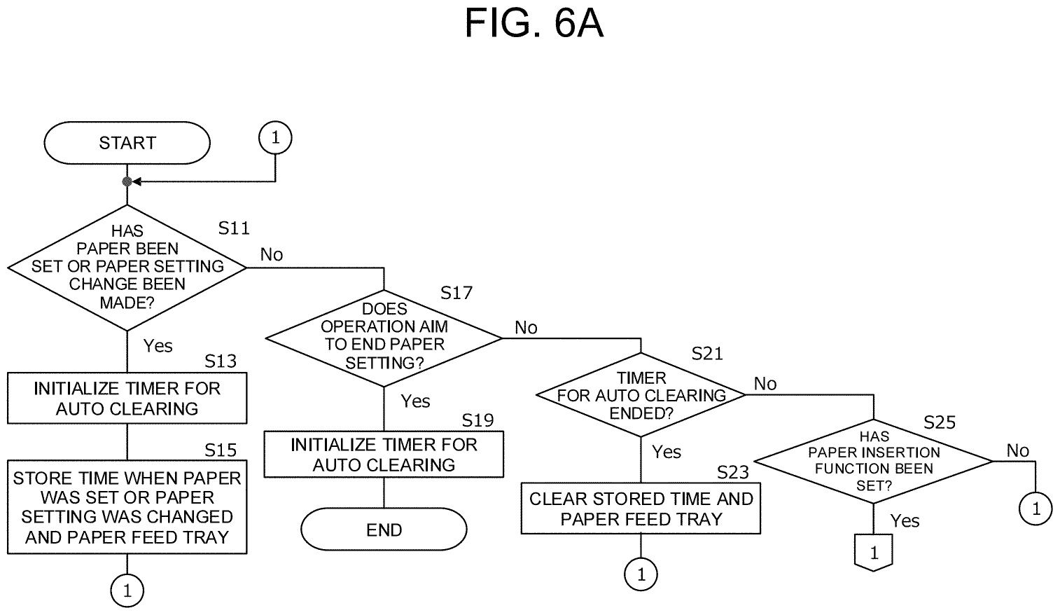

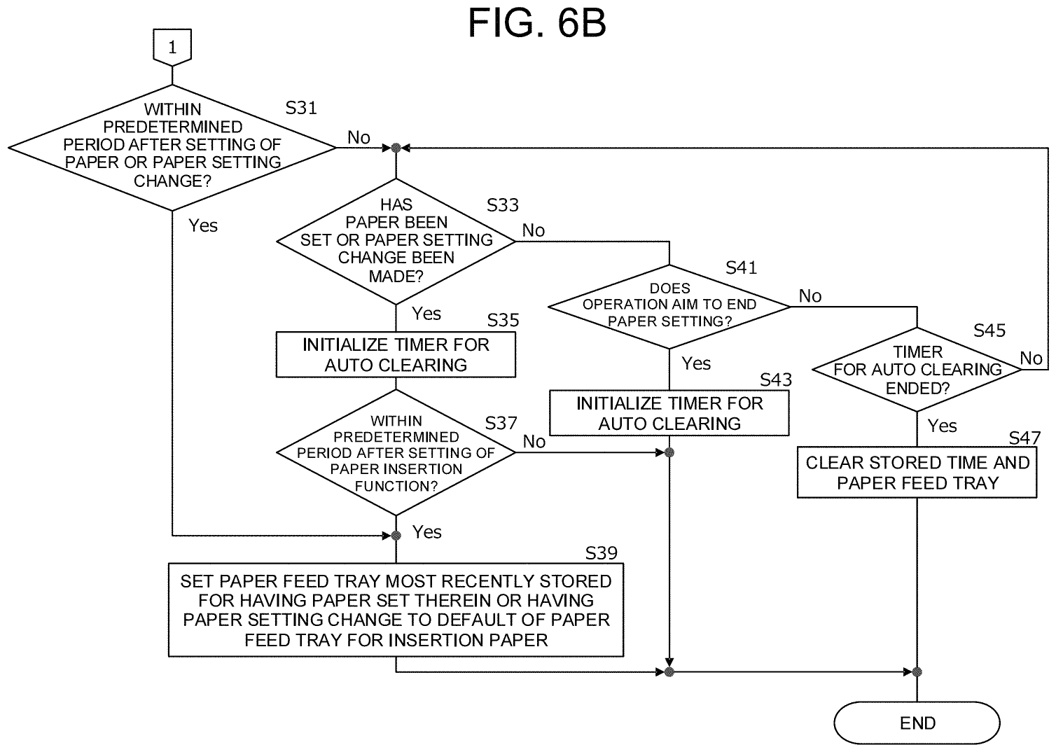

FIGS. 6A and 6B are flowcharts illustrating a specific example of the print setting related to the paper insertion function, in processing to be executed by the controller 11 of the digital multifunction peripheral 100.

In FIG. 6A, in the controller 11, the menu controller 11c receives the processing in connection with the operation screen (i.e., the screens illustrated in FIGS. 4A to 4D and FIGS. 5A to 5C) displayed on the operating unit 10 or for the paper feed tray. Here, the processing received by the controller 11 is that received as the print setter 11a.

The controller 11 sequentially monitors whether new paper has been set in one of the paper feed trays or whether the paper setting has been changed on the screens of FIGS. 4A to 4D, for example (step S11 of FIG. 6A). When it is determined that the paper has been set or the paper setting has been changed (Yes in step S11), the controller 11 initializes a timer for auto clearing in response to the operation (step S13). The timer for auto clearing is a timer which monitors whether an operation has been received during a period of from when the timer is initialized and a predetermined time has elapsed to when the timer is ended. Here, the timer is initialized in response to the operation. After the initialization, timekeeping continues until the timer is ended.

Further, the controller 11 stores the time when the paper was set or the paper setting was changed, and a target paper feed tray in the memory (step S15).

After that, the controller 11 returns the processing to the above-described step S11, and continues to monitor whether another operation has been performed.

When it is determined that no paper has been set or no paper setting has been changed in step S11 described above (No in step S11), the controller 11 next monitors whether an operation of ending the paper setting has been performed (step S17). The operation of ending the paper setting corresponds to the operation of touching the “OK” button on the screen shown in FIG. 4B, for example.

When the operation of ending the paper setting is performed (Yes in step S17), the controller 11 initializes the timer for auto clearing in response to the operation (step S19). Then, the processing is ended. Since the controller 11 sequentially repeats the processing of FIG. 6A by multitasking in parallel with the other processing, the monitoring of step S11 is performed if the task of FIG. 6A is next started after an end of the processing.

When it is determined that no operation of ending the paper setting has been performed in step S17 described above (No in step S17), the controller 11 next determines whether the timer for auto clearing is ended, in other words, whether a predetermined period has elapsed without any operation having been performed (step S21). When the timer for auto clearing is ended (Yes in step S21), the controller 11 clears, for example, the time and the paper feed tray stored in the memory in the processing of step S15 described above (step S23). Then, the processing is returned to step S11 described above, and the monitoring of the next operation is continued.

If it is determined in step S21 described above that the timer for auto clearing has not been ended yet (No in step S21), the controller 11 next determines whether the setting or change has been made for any of the paper insertion functions (step S25).

When it is determined that the setting or change has been made for the paper insertion function (Yes in step S25), the controller 11 moves the processing to step S31 shown in FIG. 6B. The setting or change for the paper insertion function corresponds to, for example, accepting the change of the paper type on the paper type setting screen 43 shown in FIG. 4D described above, or accepting the change of the paper feed tray for the insertion paper on the cover sheet insertion setting screen 46 of FIG. 5C. Meanwhile, if it is determined that no setting or change has been made for the paper insertion function, the controller 11 returns the processing to step S11 described above.

In step S31 of FIG. 6B, the controller 11 checks, with respect to the setting determined as having been made for the paper insertion function in the preceding step S25, whether paper has been set or the paper setting has been changed within a predetermined period of before the setting of the paper insertion function (step S31). That is, by referring to the time when the paper was set or the paper setting was changed that is stored in the memory, it is checked whether an applicable one is stored.

When the applicable one is stored in the memory (Yes in step S31), the controller 11 sets the stored paper feed tray which is involved with the setting of paper or the paper setting change to the default of a paper feed tray for the insertion paper (step S39), and ends the processing.

A series of the above steps of processing corresponds to, when the paper insertion function is set, setting the paper feed tray in which the paper has been set or for which the paper setting has been changed before the time of the paper insertion function setting to a default setting paper feed tray for the insertion paper.

Meanwhile, if the applicable one is not stored in the memory in step S31 described above (No in step S31), the controller 11 next checks whether paper has been set or the paper setting has been changed after the setting or change made for the paper insertion function in step S25 described above (step S33).

When it is determined that the paper has been set or the paper setting has been changed after the setting or change made for the paper insertion function (Yes in step S33), the controller 11 initializes the timer for auto clearing in response to the operation (step S35). Then, it is determined whether the operation has been performed within a predetermined period of after the setting or change made for the paper insertion function in step S25 described above (step S37).

When it is determined that the operation has been performed within the predetermined period of after the setting or change made to the paper insertion function (Yes in step S37), the controller 11 sets the paper feed tray in which the paper has been set or for which the paper setting change has been made in step S33 described above to the default of a paper feed tray for the insertion paper (step S39), and ends the processing.

A series of the above steps of processing corresponds to, when the paper insertion function is set, setting the paper feed tray in which the paper has been set or for which the paper setting has been changed after the time of the paper insertion function setting to a default setting paper feed tray for the insertion paper.

Note that in the determination of step S37, when it is determined that the operation is performed after the elapse of the predetermined period from making the setting or change to the paper insertion function (No in step S37), the processing is ended without performing the default setting of step S39 described above.

When it is determined that no paper has been set or no paper setting has been changed in step S33 described above (No in step S33), the controller 11 next monitors whether an operation of ending the paper setting has been performed (step S41).

When the operation of ending the paper setting is performed (Yes in step S41), the controller 11 initializes the timer for auto clearing in response to the operation (step S43). Then, the processing is ended.

When it is determined that no operation of ending the paper setting has been performed in step S41 described above (No in step S41), the controller 11 next determines whether the timer for auto clearing is ended, in other words, whether a predetermined period has elapsed without any operation having been performed (step S45). When the timer for auto clearing is ended (Yes in step S45), the controller 11 clears, for example, the time and the paper feed tray stored in the memory in the processing of step S15 described above (step S47). Then, the processing is ended.

Meanwhile, when it is determined that the timer for auto clearing has not been ended yet (No in step S45), the controller 11 returns the processing to step S33 described above, and continues to monitor the setting of paper or the paper setting change.

As described above, when the paper insertion function is set, the controller 11 sets the paper feed tray in which the paper has been set or for which the paper setting change has been made within each of predetermined periods of before and after the time of the paper insertion function setting to a default setting paper feed tray for the insertion paper.

In the flowcharts of FIGS. 6A and 6B, the paper feed tray in which the paper has been set or for which the paper setting change has been made within a predetermined period, which is either before or after the time of setting the paper insertion function, is set as the default setting for the insertion paper. However, only a predetermined period of before the aforementioned time or only a predetermined period of after the aforementioned time may be applied as the predetermined period.

### Embodiment 2

In the present embodiment, the mode of setting, when a paper insertion function is set, a default setting of the paper type of insertion paper according to the set paper insertion function will be described.

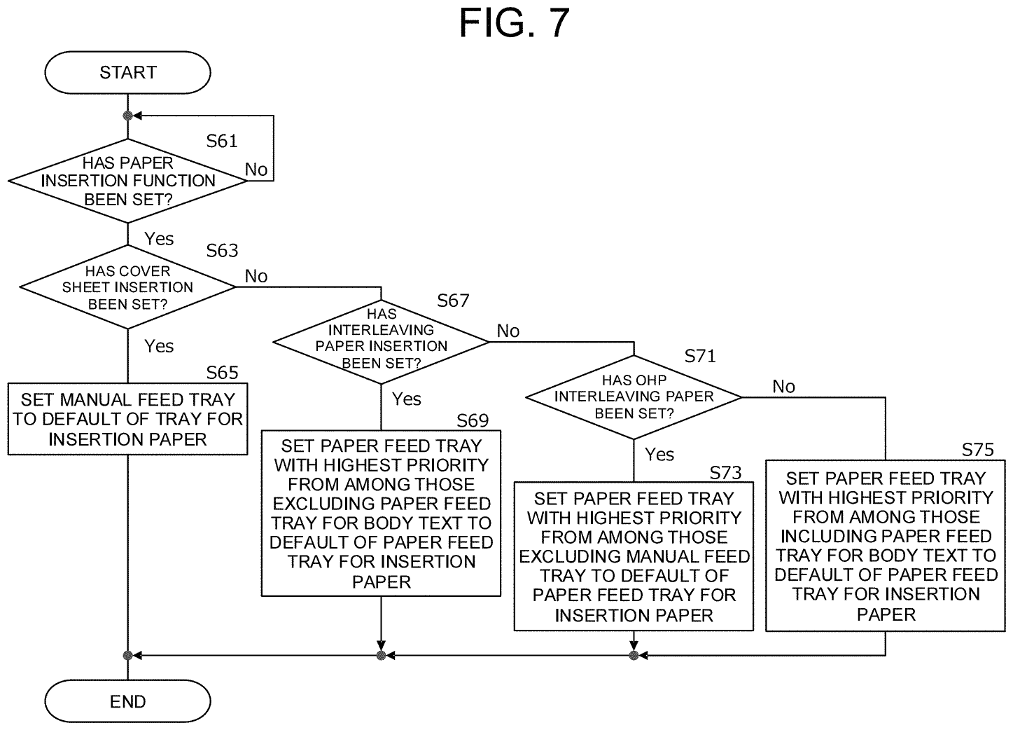

FIG. 7 is a flowchart illustrating a specific example of print setting processing related to a paper insertion function of the present embodiment, in processing to be executed by a controller 11 of a digital multifunction peripheral 100.

In FIG. 7, the controller 11 waits for the setting or change to be made for one of the paper insertion functions (Yes in step S61), and determines the paper insertion function that has been set.

First, it is determined whether the set or changed paper insertion function corresponds to cover sheet insertion (step S63). When the cover sheet insertion is applied (Yes in step S63), the controller 11 sets a manual feed tray 17b as the default of a paper feed tray for insertion paper (step S65), and ends the processing. Paper different from that of a body text such as thick paper or the like is often used for a cover sheet, and the manual feed tray 17b is often used as the paper feed tray for the insertion paper of the cover sheet. It is rare that special paper such as thick paper is constantly set in a paper feed tray, and in most cases, thick paper or the like for the cover sheet is set in the manual feed tray 17b as needed.

Meanwhile, when it is determined by the controller 11 that the set or changed paper insertion function does not correspond to the cover sheet insertion (No in step S63), it is determined whether the set or changed paper insertion function corresponds to interleaving paper insertion (step S67). In the case of the interleaving paper insertion (Yes in step S67), the controller 11 sets the paper feed tray with the highest priority, from among those excluding the paper feed tray for the body text, as the default of a paper feed tray for the insertion paper (step S69), and ends the processing.

As the paper type of the interleaving paper, colored plain paper or printed plain paper is often used. Further, as the insertion paper for the interleaving paper, in most cases, paper different from that of the body text is used. Therefore, the paper feed tray with the highest priority, from among those excluding the paper feed tray for the body text, is set as the default of a paper feed tray for the insertion paper.

Here, the priority of the paper feed tray is determined as described below, for example. First, if a paper feed tray to be prioritized (a priority tray) is set by a user, the set priority tray is selected as the highest priority.

Next, priorities are defined in the order described below for each type of the paper feed tray. First, the large-capacity tray 17c is prioritized. Next, the multistage tray 17a is prioritized. Lastly, the manual feed tray 17b is selected. The above order is based on the frequency (probability) with which each paper feed tray is normally selected. In the multistage tray 17a, priorities are defined in the order of the paper feed tray with the shortest paper feeding path, in other words, the topmost tray 1, to the bottommost tray 4.

Now, explanation of the flowchart is continued.

In the determination of step S67 described above, when it is determined by the controller 11 that the set or changed paper insertion function does not correspond to the interleaving paper insertion (No in step S67), it is determined whether the set or changed paper insertion function corresponds to OHP film interleaving paper insertion (step S71). In the case of the OHP film interleaving paper insertion (Yes in step S71), the controller 11 sets the paper feed tray with the highest priority, from among those excluding the manual feed tray 17b, as the default of a paper feed tray for the insertion paper (step S73), and ends the processing.

The manual feed tray 17b is often used as the paper feed tray for the OHP films. Therefore, among the paper feed trays other than the manual feed tray 17b in which the OHP films for use in printing the body text are set, the paper feed tray with the highest priority is set as the default of a paper feed tray for the insertion paper.

Meanwhile, in the determination of step S71 described above, when it is determined by the controller 11 that the set or changed paper insertion function does not correspond to the OHP film interleaving paper insertion (No in step S71), the controller 11 determines that the set or changed paper insertion function corresponds to partition paper insertion, which is the last remaining function of the paper insertion function. The controller 11 sets the paper feed tray with the highest priority, from among those including the paper feed tray for the body text, as the default of a paper feed tray for the insertion paper (step S75), and ends the processing.

Since the partition paper is merely a sheet of paper for a partition, it may be often the case that the same type of paper as that of the body text is used. Therefore, the paper feed tray with the highest priority from among the paper feed trays including the paper feed tray for the body text is set as the default of a paper feed tray for the insertion paper.

As described above, in the present embodiment, the controller 11 sets a default setting of the paper type of the insertion paper according to the set paper insertion function.

### Embodiment 3

In the present embodiment, explanation will be given for the mode in which a controller 11 stores at least either custom settings for each user or a history of a job related to paper insertion function, and sets, in a case where the paper insertion function is set, a default setting of the paper type of insertion paper on the basis of at least either the custom settings or the history.

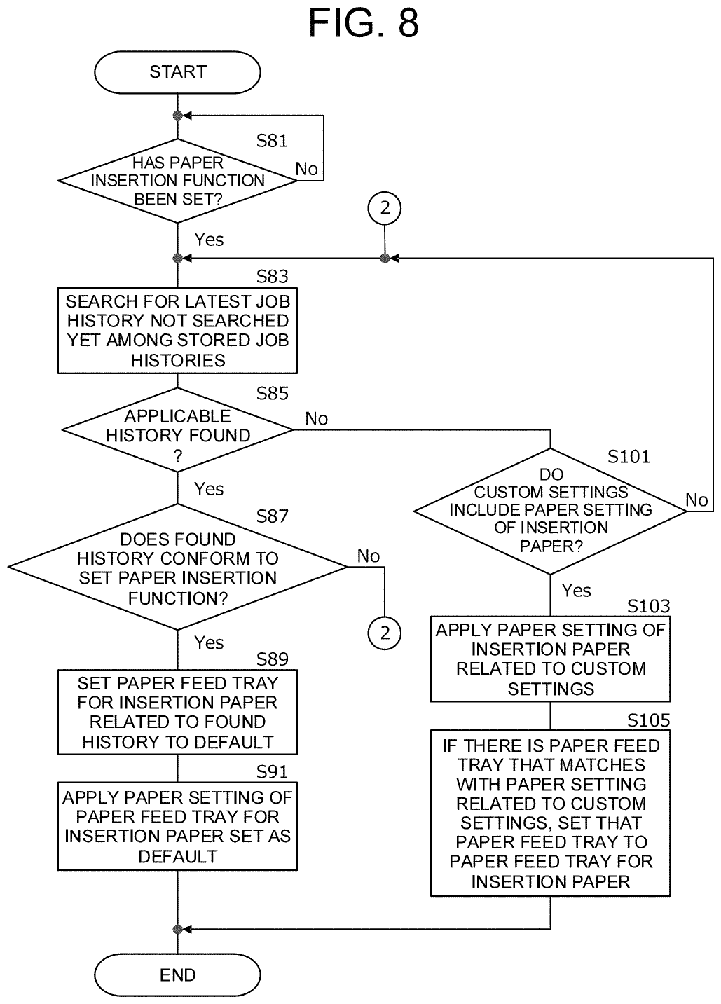

FIG. 8 is a flowchart illustrating a specific example of print setting processing related to the paper insertion function of the present embodiment, in processing to be executed by the controller 11 of a digital multifunction peripheral 100. FIG. 8 corresponds to an example of a mode in which the job history and the custom settings are both stored. However, if only one of the job history and the custom settings is stored, the other counterpart processing in FIG. 8 may be omitted.

In FIG. 8, the controller 11 waits for the setting or change to be made for one of the paper insertion functions (Yes in step S81), and then first refers to a job history.

The controller 11 searches the stored histories of print jobs in order from the latest job history, and checks whether the history of the same job as that of the set paper insertion function is stored. In order to do so, first, among the stored job histories, a search is made for the latest job history among the ones that have not been searched yet (step S83).

If there is an applicable history (Yes in step S85), it is determined whether the history conforms to the set paper insertion function (step S87). If the history conforms to the set paper insertion function (Yes in step S87), the controller 11 sets the paper feed tray for insertion paper related to that history as the default of a paper feed tray for the insertion paper of the set paper insertion function (step S89), and applies the paper setting of the set paper feed tray as the default of the paper type of the insertion paper (step S91).

That is, the paper feed tray used for the same job as the most recent job corresponding to the set paper insertion function is selected as the paper feed tray for the insertion paper, and is set to the default by applying the paper type corresponding to that paper feed tray. Then, the processing is ended.

In the determination of step S87 described above, if the history, which is the target of search, does not conform to the set paper insertion function (No in step S87), the controller 11 returns the processing to step S83 described above, and searches for the next history. That is, a search is made for the latest history from among the histories that have not been searched yet.

Further, in the determination of step S85 described above, if an applicable history is not found (No in step S85), it is determined that the paper feed tray for the insertion paper cannot be selected on the basis of the history, and the controller 11 refers to the custom settings of each user (step S101).

Here, the custom settings refer to the settings that can be called by a predetermined operation, which is enabled by having the settings frequently used by the user stored in a memory. In this case, the user is an authenticated user who has gone through the authentication processing by the digital multifunction peripheral 100, and the custom settings are stored in an individual memory area specific to the authenticated user.

If the custom settings of the authenticated user include the setting corresponding to the set paper insertion function (Yes in step S101), the controller 11 sets the paper setting of the insertion paper in the applicable custom settings as the default of the paper setting of the insertion paper related to the set paper insertion function. Even if an operation of calling the custom settings is not performed, the default is set in the way as described above (step S103). If there is a paper feed tray which corresponds to the paper setting in question, the corresponding paper feed tray is set as the default of a paper feed tray for the insertion paper (step S105). Then, the processing is ended.

As described above, in the present embodiment, the controller 11 sets a default setting of the paper type of the insertion paper on the basis of at least one of the job history and the custom settings.

### Embodiment 4

In the present embodiment, explanation will be given for the mode in which a controller 11 sets, when an article of a certain size such as an OHP film or index paper is set as the paper type of insertion paper of the set paper insertion function, the paper feed tray of the corresponding paper size as the default of a paper feed tray for the insertion paper.

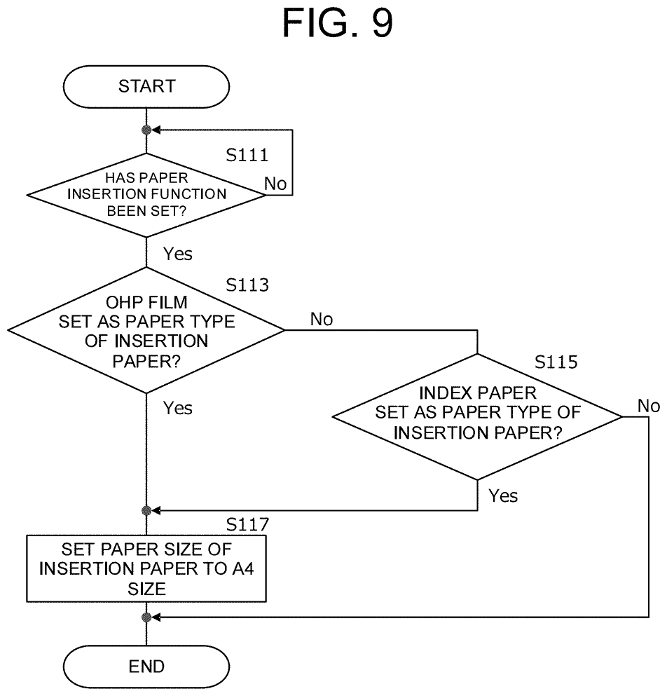

FIG. 9 is a flowchart illustrating a specific example of print setting processing related to the paper insertion function of the present embodiment, in processing to be executed by the controller 11 of a digital multifunction peripheral 100.

In FIG. 9, the controller 11 waits for the setting or change to be made for one of the paper insertion functions (Yes in step S111), and determines the paper type of the insertion paper (not the paper type of the body text) related to the set paper insertion function.

When an OHP film is set as the paper type of the insertion paper (Yes in step S113), the controller 11 sets the paper size of the insertion paper to A4 size (step S117). If there is a matching paper feed tray in terms of the paper type and paper size of the insertion paper, the matching paper feed tray is set as the default of a paper feed tray for the insertion paper, and the processing is ended.

In the determination of step S113 described above, when it is determined that the set paper type of the insertion paper does not correspond to the OHP film (No in step S113), the controller 11 next determines whether the set paper type of the insertion paper corresponds to index paper (step S115). If the set paper type of the insertion paper does not correspond to the index paper (No in step S115), the processing is ended. However, if the set paper type corresponds to the index paper (Yes in step S115), the paper size of the insertion paper is set to A4 size (step S117). If there is a matching paper feed tray in terms of the paper type and paper size of the insertion paper, the matching paper feed tray is set as the default of a paper feed tray for the insertion paper, and the processing is ended.

As described above, according to the present embodiment, for those whose paper size is determined correspondingly to the paper type of the insertion paper, the paper size corresponding to that paper type is set as the paper size of the insertion paper. Further, if there is an applicable paper feed tray, that paper feed tray is set as the default of a paper feed tray for the insertion paper.

The size of the OHP film and the index paper is normally A4. Therefore, when the above type of articles is set as the paper type, the paper size thereof is set to a normal size.

As another mode, when thick paper, colored paper, or printed paper is set as the paper type of the insertion paper, the same paper size as that of the body text may be set as the default. A normal size of the paper as mentioned above is not determined as in the case of the OHP film or the index paper. Therefore, when the paper as mentioned above is set as the paper type, the paper size of the body text is set to the default of the size of the insertion paper.

As yet another mode, when an irregular size is set as the paper size of the insertion paper, the default of the paper type of the insertion paper may be set to thick paper. This is because in cases where insertion paper of an irregular size is used, the insertion paper is mostly thick paper.

As described above,

(i) A print control apparatus according to the present invention is characterized by comprising: a print setter which accepts, when printing with paper insertion function is to be performed, a setting by a user related to the paper insertion function; a paper information acquirer which acquires information related to a paper setting of at least one of at a point of time of setting the paper insertion function, before the point of time, and after the point of time, as paper information; and a menu controller which determines a default setting of a menu which accepts the setting of the paper insertion function based on the acquired paper information.

In the present invention, the paper insertion function refers to the function of inserting paper such as a cover sheet, interleaving paper, and partition paper at a set position at the time of printing a body text. On the paper to be inserted in the body text, printing may or may not be performed. The reason why the paper insertion function is provided specifically is that a paper feed tray for use in printing the body text and a paper feed tray to be used for insertion paper are different. For this reason, the setting of the paper insertion function includes the setting of an insertion position of the insertion paper relative to the body text. Further, the setting of the paper insertion function includes the setting of the paper feed tray for the insertion paper, separately from the setting of the paper feed tray for the body text. Furthermore, the setting of the paper insertion function may also include the setting of the paper type of the insertion paper, separately from the setting of the paper type for the body text.

The paper feed tray refers to a tray which stores and supplies printing paper. The multistage tray 17a, the manual feed tray 17b, and the large-capacity tray 17c of each of the above-described embodiments all correspond to the paper feed tray of the present invention.

Further, preferred modes of the present invention will be described.

(ii) The menu controller may set, when the paper insertion function is set, a paper feed tray in which paper has been set or for which the paper setting has been changed at least one of before and after the point of time of the paper insertion function setting to a default setting paper feed tray for insertion paper.

By such a configuration, it is possible to determine a paper feed tray in which the paper has been set, or a paper feed tray whose paper setting has been changed, at least one of before and after the point of time of setting the paper insertion function, as being the one in which the insertion paper has been set or for which the paper setting related to the insertion paper has been made, and apply that paper feed tray to a default setting of the paper feed tray for the insertion paper.

(iii) The menu controller may determine, when the paper insertion function is set, a default setting of a paper type of insertion paper according to the set paper insertion function.

For example, when interleaving paper insertion is set, if there is only one paper feed tray whose paper size is the same as that of the body text other than the paper feed tray for the body text, that paper feed tray may be applied to a default setting of insertion paper. Also, since thick paper is often inserted in the case of cover sheet insertion, a manual feed tray corresponding to the thick paper may be applied to a default setting of the insertion paper.

By such a configuration, it is possible to determine the default setting of the paper type of the insertion paper according to the set paper insertion function.

(iv) The paper information acquirer may store histories of paper settings, and the menu controller may refer to the stored histories when the paper insertion function is set, and determine a default setting of at least one of a paper feed tray and a paper type of insertion paper.

By such a configuration, it is possible to apply a paper feed tray which is highly likely to be selected as the paper feed tray for insertion paper to a default setting on the basis of the histories of the paper settings.

(v) The menu controller may determine, when the paper insertion function is set, a paper feed tray which is to be prioritized according to the set paper insertion function, and apply the paper feed tray with the highest priority to a default setting paper feed tray for insertion paper.

By such a configuration, it is possible to apply, when the paper feed tray to be prioritized differs according to the set paper insertion function, the paper feed tray with the highest priority according to each of the functions to a default setting.

(vi) A preferred mode of the present invention includes a print control method comprising: accepting, when printing with paper insertion function is to be performed, a setting by a user related to the paper insertion function; acquiring information related to a paper setting of at least one of at a point of time of setting the paper insertion function, before the point of time, and after the point of time, as paper information; and determining a default setting of a menu which accepts the setting of the paper insertion function based on the acquired paper information.

The preferred modes of the present invention also include a combination of any of the above-described modes.

Various modifications of the present invention may be implemented besides the above-described embodiments. Such modifications should not be construed as falling outside the scope of the present invention. The present invention is embodied by the claims and their equivalents, and should embrace all of the modifications within the scope of the above.

What is claimed is:

1. A print control apparatus comprising:
a processor; and
a memory,
wherein the memory stores instructions that cause the processor to:
accept, when printing with paper insertion function is to be performed, a setting by a user related to the paper insertion function;
acquire information related to a paper setting of at least one of at a point of time of setting the paper insertion function, before the point of time, and after the point of time, as paper information; and
determine a default setting of a menu which accepts the setting of the paper insertion function based on the acquired paper information.

2. The print control apparatus according to claim 1, wherein, when the paper insertion function is set, a paper feed tray in which paper has been set or for which the paper setting has been changed at least one of before and after the point of time of the paper insertion function setting is set to a default setting paper feed tray for insertion paper.

3. The print control apparatus according to claim 1, wherein, when the paper insertion function is set, a default setting of a paper type of insertion paper is determined according to the set paper insertion function.

4. The print control apparatus according to claim 1, wherein:
histories of the paper information are stored, and
the stored histories when the paper insertion function is set are referred to, and a default setting of at least one of a paper feed tray and a paper type of insertion paper are determined.

5. The print control apparatus according to claim 1, wherein, when the paper insertion function is set, a paper feed tray which is to be prioritized according to the set paper insertion function is determined, and the paper feed tray with the highest priority is applied to a default setting paper feed tray for insertion paper.

6. A print control method comprising:
accepting, when printing with paper insertion function is to be performed, a setting by a user related to the paper insertion function;
acquiring information related to a paper setting of at least one of at a point of time of setting the paper insertion function, before the point of time, and after the point of time, as paper information; and
determining a default setting of a menu which accepts the setting of the paper insertion function based on the acquired paper information.
